(19) United States
(12) Patent Application Publication
(10) Pub. No.: US 2020/0091614 A1
(43) Pub. Date: Mar. 19, 2020

(54) ANTENNA DEVICE AND DISPLAY APPARATUS INCLUDING THE SAME

(71) Applicant: SHARP KABUSHIKI KAISHA, Sakai City, Osaka (JP)

(72) Inventors: SHINJI YAMAGISHI, Sakai City, Osaka (JP); YASUHIRO SUGITA, Sakai City, Osaka (JP); JEAN MUGIRANEZA, Sakai City, Osaka (JP)

(21) Appl. No.: 16/618,740

(22) PCT Filed: Jun. 5, 2018
(86) PCT No.: PCT/JP2018/021439

§ 371 Date: Dec. 2, 2019

(30) Foreign Application Priority Data
Jun. 8, 2017 (JP) 2017-113416

(51) Int. Cl. H01Q 19/02; H01Q 1/24; H01Q 7/00; H04W 4/80

(52) U.S. Cl. CPC H01Q 19/021; H04W 4/80; H01Q 7/00; H01Q 1/24

(57) ABSTRACT

An antenna device adopting a repeater antenna technique and entirely having small thickness is provided. Also, a display apparatus including the antenna device is provided. The antenna device includes an antenna substrate (121), a main antenna (12M) configured to transmit and receive information through near field wireless communication, and a repeater antenna (12R). The main antenna (12M) and the repeater antenna (12R) are disposed on a principal surface of the antenna substrate (121).

### TECHNICAL FIELD

The following disclosure relates to an antenna device, in particular an antenna device including an antenna for near field wireless communication, and a display apparatus including the antenna device.

### BACKGROUND ART

In recent years, there has often been adopted a technique for near field communication between an IC card (contactless IC card) not including any power supply but including a wireless communication antenna element, and a communication device including a power supply, without contact between the IC card and the communication device. In an exemplary case where the communication device and the contactless IC card make wireless communication (near field communication), the contactless IC card is brought close to the communication device so as to be distant by at most a predetermined distance from an antenna element of the communication device. When the communication device including the power supply supplies electric power to the antenna element for near field wireless communication incorporated therein, the antenna element generates a magnetic field. The magnetic field generated by the communication device causes induced current to flow to the antenna element of the contactless IC card that is brought close to the communication device. This achieves supply of electric power from the communication device to the contactless IC card. The contactless IC card causes a circuit (e.g. an IC chip) provided in the contactless IC card to operate by means of electromotive force generated by the induced current. This enables wireless communication (near field communication) between the communication device and the contactless IC card that is brought close to the communication device.

### CITATION LIST

### Patent Literature

Patent Literature 1: JP 2014-123925 A

### SUMMARY

### Technical Problem

There has also been adopted a so-called repeater antenna technique for improvement in antenna performance. The repeater antenna technique keeps power supply efficiency and enhances power supply distance and power supply range by disposing, between a power transmitting device and a power receiving device, a repeater device configured to resonate at a frequency equal to those of these devices.

When such a repeater antenna technique is applied to an antenna device, the antenna device is desired to have no increase in thickness due to an incorporated repeater antenna.

In view of this, it is an object of the following disclosure to achieve reduction in thickness of an antenna device adopting a repeater antenna technique.

### Solution to Problem

In order to achieve the object mentioned above, an antenna device according to an embodiment includes: an antenna substrate; a main antenna configured to transmit and receive information through near field wireless communication, and a repeater antenna; in which the main antenna and the repeater antenna are disposed on a principal surface of the antenna substrate.

### Advantageous Effect

The above configuration achieves provision of the antenna device adopting the repeater antenna technique and entirely having small thickness.

### BRIEF DESCRIPTION OF DRAWINGS

FIG. 1 is a sectional view depicting a schematic configuration of a liquid crystal display apparatus 1 according to a first embodiment.

FIG. 2 is a pattern diagram depicting an exemplary configuration of an antenna layer according to the first embodiment.

FIG. 3 is a pattern diagram depicting an antenna layer according to a comparative example of the first embodiment.

FIG. 4 is a pattern diagram depicting another exemplary configuration of the antenna layer according to the first embodiment.

FIG. 5 is a pattern diagram depicting an exemplary configuration of an antenna layer according to a second embodiment.

FIG. 6 is a pattern diagram depicting another exemplary configuration of the antenna layer according to the second embodiment.

FIG. 7 is a pattern diagram depicting an exemplary configuration of an antenna layer according to a third embodiment.

FIG. 8 is a pattern diagram depicting another exemplary configuration of the antenna layer according to the third embodiment.

FIG. 9 is a pattern diagram depicting an exemplary configuration of an antenna layer according to a fourth embodiment.

FIG. 10 is a schematic view indicating a method of evaluating an EMVCo characteristic for measurement of antenna performance in each of the first to fourth embodiments.

### DESCRIPTION OF EMBODIMENTS

The following description relates to the embodiments of the invention.

An antenna device according to a first configuration includes: an antenna substrate; a main antenna configured to transmit and receive information through near field wireless communication, and a repeater antenna; in which the main antenna and the repeater antenna are disposed on a principal surface of the antenna substrate.

The main antenna and the repeater antenna are disposed on an identical plane. This configuration enables provision of the repeater antenna without increase in entire thickness of the antenna device. This achieves both reduction in thickness of the antenna device and improvement in antenna performance.

Optionally in the first configuration, the main antenna has a loop shape, and the repeater antenna has a loop shape surrounding an outer periphery of the main antenna (a second configuration).

Alternatively, optionally in the first configuration, the repeater antenna has a loop shape, and the main antenna has a loop shape surrounding an outer periphery of the repeater antenna (a third configuration).

Alternatively, optionally in the first configuration, the main antenna has a loop shape, the repeater antenna has a loop shape, and the main antenna and the repeater antenna are disposed alternately from a center toward an outer periphery of the antenna substrate (a fourth configuration).

Optionally, any one of the first to third configurations further includes a wiring substrate connected to the antenna substrate, in which the main antenna and the repeater antenna include connection lines provided on the wiring substrate (a fifth configuration).

The connection lines on the wiring substrate in this configuration are utilized to obtain the loop shapes of the main antenna and the repeater antenna.

In the fifth configuration, the connection lines may be further at least partially disposed in layers different from each other on the wiring substrate (a sixth configuration).

The connection lines crossing in a planar view are disposed in the layers different from each other on the wiring substrate. This configuration achieves prevention of electrical contact between the connection lines as well as reduction in wiring area on the wiring substrate.

According to another embodiment, there is provided a display apparatus including the antenna device according to any one of the first to sixth configurations and a display module configured to display an image (a seventh configuration). This configuration achieves reduction in thickness of the entire display apparatus as well as improvement in antenna performance of the antenna device.

Optionally, in the seventh configuration, the display module is stacked on the antenna device, and the main antenna and the repeater antenna are at least partially made of metal mesh (an eighth configuration).

The metal mesh transmits light through mesh openings. When the main antenna and the repeater antenna are at least partially made of such metal mesh, the display module including a stacked antenna device has a portion corresponding to a display region and provided with an antenna.

Optionally, in the eighth configuration, the main antenna and the repeater antenna have a portion disposed in a region corresponding to outside a display region of the display module on the antenna substrate, and the portion is made of meshless metal wire (a ninth configuration).

In this configuration, the antenna disposed in the region (a so-called a frame region) corresponding to outside the display region of the display module is made of the meshless metal wire. The meshless metal wire is lower in resistivity than an antenna line made of metal mesh that is equal in width to the meshless metal wire. The ninth configuration thus achieves improvement in antenna performance in comparison to a configuration including an antenna line entirely made of metal mesh.

### Embodiments

The embodiments of the present invention will now be described in detail below with reference to the drawings. Identical or corresponding parts in the drawings will be denoted by identical reference signs and ill not be described repeatedly. For clearer description, the drawings to be referred to hereinafter may depict simplified or schematic configurations or may not include some of constituent elements. The constituent elements in each of the drawings may not necessarily be depicted in actual dimensional ratios.

### First Embodiment

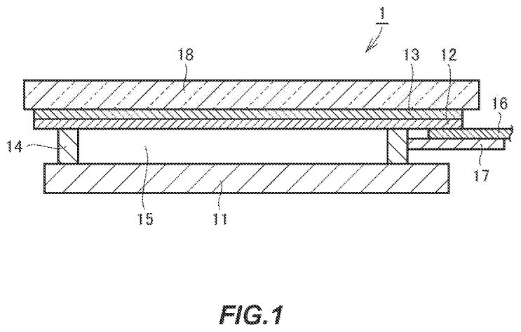

FIG. 1 is a sectional view depicting a schematic configuration of a liquid crystal display apparatus 1 according to the first embodiment. As depicted in FIG. 1, the liquid crystal display apparatus 1 has a layered structure including a liquid crystal module 11, an antenna layer 12, a touch panel 13, and a glass cover 18. The antenna layer 12 is bonded to the liquid crystal module 11 by means of an adhesive member 14. Examples of the adhesive member 14 include a double sided tape. FIG. 1 exemplifies the adhesive member 14 having certain thickness. The liquid crystal module 11 and the antenna layer 12 accordingly have an air gap 15 provided therebetween. The air gap 15 may not necessarily be provided.

The antenna layer 12 according to the present embodiment includes a near field communication (NFC) antenna for near field wireless communication with external equipment. Communication with the external equipment is not limited to NFC in tents of its protocol. The antenna layer 12 has a first principal surface having an end connected to a flexible printed circuits (FPC) substrate 16.

The antenna layer 12 has a second principal surface that is opposite to the first principal surface connected to the FPC substrate 16 and is provided thereon with the touch panel 13. The touch panel 13 is not an essential constituent element. The touch panel 13 is provided thereon with the glass cover 18. The glass cover 18 is not an essential constituent element.

FIG. 1 depicts the configuration including a ferrite sheet 17 exhibiting a magnetic field shielding effect and provided on a surface of the FPC substrate 16 opposite to a surface in contact with the antenna layer 12. The ferrite sheet 17 is not an essential constituent element, and can be replaced with any other sheet exhibiting the magnetic field shielding effect.

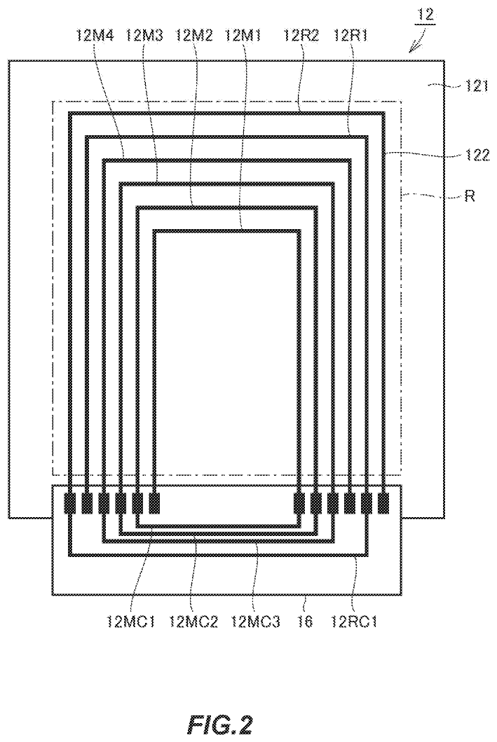

The antenna layer 12 will be described in detail below with reference to FIG. 2. FIG. 2 is a pattern diagram depicting an exemplary configuration of the antenna layer 12 according to the first embodiment. The antenna layer 12 includes an antenna substrate 121 made of a synthetic resin material such as polyethylene terephthalate (PET), and an antenna pattern 122 obtained by patterning metal mesh (a meshed metal film) into lines on the antenna substrate 121.

As depicted in FIG. 2, the antenna pattern 122 includes a main antenna 12M and a repeater antenna 12R. The main antenna 12M and the repeater antenna 12R are both formed by patterning metal mesh, to be provided on a surface of the antenna substrate 121, in other words, on an identical plane. FIG. 2 exemplifies the main antenna 12M having a four-winding loop shape. The repeater antenna 12R is provided to surround an outer end of the main antenna 12M, and has a two-winding loop shape.

The main antenna 12M includes antenna lines 12M1 to 12M4 made of metal mesh and provided on the antenna substrate 121, and connection lines 12MC1 to 12MC3 made of meshless metal wire and provided on the FPC substrate 16.

As depicted in FIG. 2, the connection line 12MC1 connects a first end of the antenna line 12M1 and a first end of the antenna line 12M2. The connection line 12MC2 connects a second end of the antenna line 12M2 and a first end of the antenna line 12M3. The connection line 12MC3 connects a second end of the antenna line 12M3 and a first end of the antenna line 12M4. The main antenna 12M thus has a four-winding loop shape.

The repeater antenna 12R includes antenna lines 12R1 and 12R2 made of metal mesh and provided on the antenna substrate 121, and a connection line 12RC1 made of meshless metal wire and provided on the FPC substrate 16. The connection line 12RC1 connects a first end of the antenna line 12R1 and a first end of the antenna line 12R2. The repeater antenna 12R thus has a two-winding loop shape.

The antennas are sized to have a diagonal of about five inches (about 12.7 cm), and the antenna lines 12M1 to 12M4 as well as the antenna lines 12R1 and 12R2 each have about 300 μm in width and an interval of about 50 μm from an adjacent antenna line.

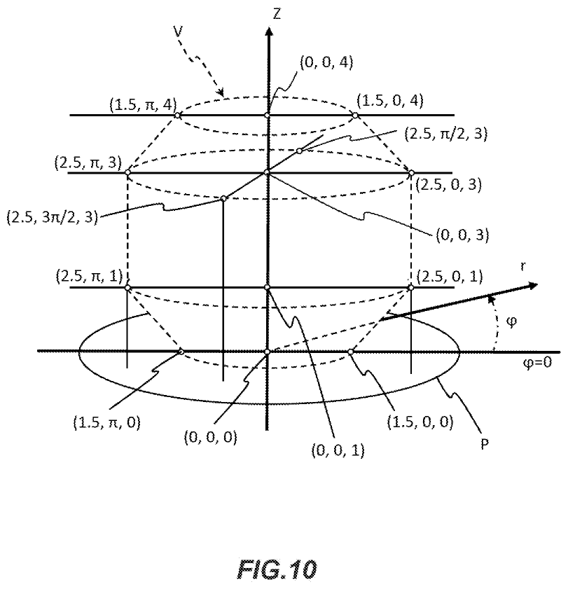

The present embodiment provides the main antenna 12M adjusted to have a resonant frequency of 14 MHz, and the repeater antenna 12R adjusted to have a resonant frequency of 20 MHz. This configuration is found to satisfy a characteristic required by EMV specifications. The EMV specifications are international de facto standard for financial transaction IC cards. A test to check whether or not the EMV specifications are satisfied includes disposing a predetermined receiving antenna for EMV standard tests to be in parallel with a display surface of the liquid crystal display apparatus 1 and be distant by 40 mm from the display surface, and measuring an amplitude peak value (EMVCo characteristic) of output voltage of the receiving antenna. A display apparatus including an antenna device satisfies the EMV specifications when the receiving antenna disposed above to be distant by 40 mm from the display surface along its normal line has at least 2.55 V as the output voltage peak value. In order to achieve the EMVCo characteristic in an entire operating volume V indicated by broken lines in FIG. 10, the receiving antenna disposed above to be distant by 40 mm from a display surface P along the normal line needs to have at least 3.0 V as the output voltage peak value. Coordinates (r, φ, z) on the operating volume V indicated in FIG. 10 include a radial position r within the display surface P, an angle φ from a reference position within the display surface P, and a height z of the display surface P along the normal line. In the present embodiment, the output voltage peak value of at least 3.0 V is achieved at the distance of 40 mm above the display surface P along the normal line.

The EMVCo characteristic has about 3.5 V in the configuration depicted in FIG. 2. This configuration accordingly satisfies the characteristic required in the EMV specifications. A current value is 0.313 A when this output voltage value is obtained.

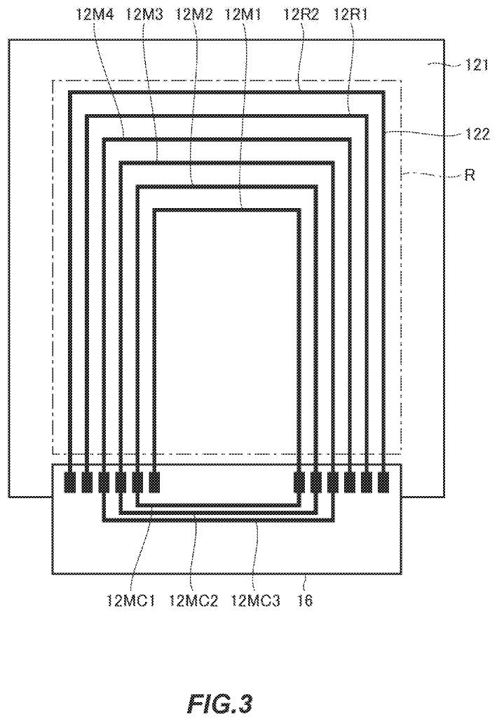

According to a comparative example depicted in FIG. 3, the connection line 12RC1 is removed from the configuration depicted in FIG. 2 and the antenna lines 12R1 and 12R2 come into a floating state to obtain a configuration including only the main antenna 12M without including any repeater antenna. The EMVCo characteristic measured under the same condition as above has 2.91 V. The current value is 0.345 A when this output voltage value is obtained. This result indicates that provision of the repeater antenna 12R leads to improvement in EMVCo characteristic as well as reduction in current value for reduction in electric power consumption.

FIG. 2 exemplarily depicts the main antenna 12M having the four-winding loop shape and the repeater antenna 12R having the two-winding loop shape. Neither the main antenna 12M nor the repeater antenna 12R is limited to the above in terms of the number of winding.

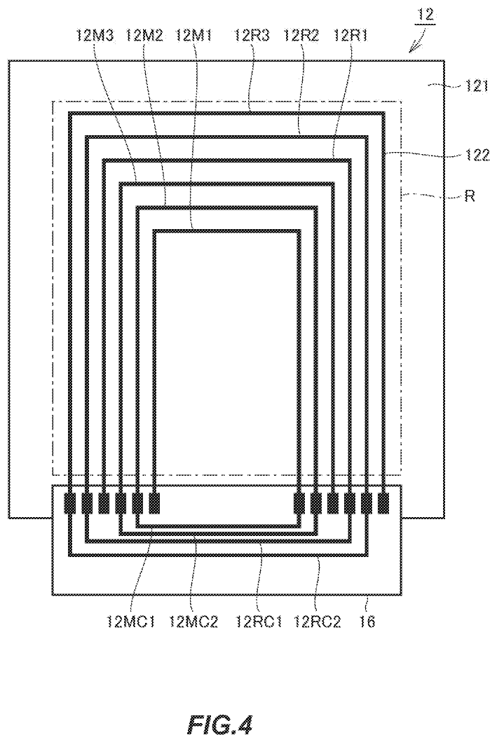

As exemplarily depicted in FIG. 4, the main antenna 12M and the repeater antenna 12R may each have three as the number of winding. In a configuration depicted in FIG. 4, the main antenna 12M has a three-winding loop shape with the antenna lines 12M1 to 12M3 and the connection lines 12MC1 and 12MC2. The repeater antenna 12R has a three-winding loop shape with the antenna lines 12R1 to 12R3 and connection lines 12RC1 and 12RC2.

The EMVCo characteristic has about 3.58 V in the configuration depicted in FIG. 4. This configuration thus also satisfies the characteristic required in the EMV specifications. The current value is 0.365 A when this output voltage value is obtained.

As described above, the present embodiment provides the configuration including the repeater antenna 12R to achieve excellent antenna performance with expanded communication distance and range. The main antenna 12M and the repeater antenna 12R are disposed on the identical plane to achieve reduction in thickness of the entire device in comparison to a configuration including the main antenna 12M and the repeater antenna 12R disposed in layers different from each other.

The numbers of winding of the main antenna 12M and the repeater antenna 12R as well as the width and the interval of the antenna lines are not limited to the specific exemplification described above, but may be appropriately adjusted to satisfy a required characteristic. For example, the EMV specifications require at least 3.0 V as the amplitude peak value of the output voltage in the test described above. A different standard may require a different characteristic. The numbers of winding of the main antenna 12M and the repeater antenna 12R as well as the width and the interval of the antenna lines vary the value of current flowing through the antenna lines. The numbers of winding, the width, and the interval may thus be adjusted to reduce electric power consumption.

The antenna lines may not necessarily be equal in width and interval. The antenna lines equal in width and interval are preferred so as to be less likely to be outstanding.

### Second Embodiment

Description is now made to the second embodiment. Components similar in function to those according to the first embodiment will be denoted by identical reference signs and will not be described in detail repeatedly. The same applies to the other embodiments to be described later.

The first embodiment provides the configuration including the repeater antenna 12R disposed along an outer periphery of the main antenna 12M. The second embodiment relates to a configuration including the main antenna 12M disposed along an outer periphery of the repeater antenna 12R in contrast to the first embodiment.

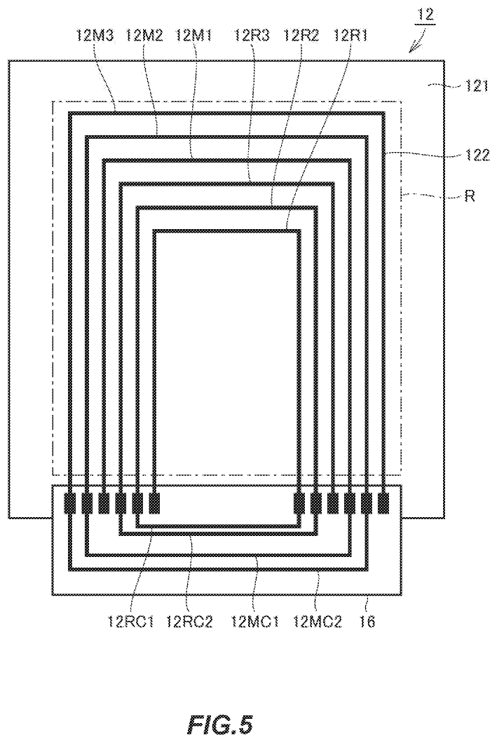

FIG. 5 is a pattern diagram depicting an exemplary configuration of the antenna layer 12 according to the second embodiment. FIG. 5 exemplarily depicts the main antenna 12M having a three-winding loop shape. The repeater antenna 12R is disposed inside the main antenna 12M, and has a three-winding loop shape.

The main antenna 12M includes the antenna lines 12M1 to 12M3 made of metal mesh and provided on the antenna substrate 121, and the connection lines 12MC1 and 12MC2 made of meshless metal wire and provided on the FPC substrate 16.

As depicted in FIG. 5, the connection line 12MC1 connects the first end of the antenna line 12M1 and the first end of the antenna line 12M2. The connection line 12MC2 connects the second end of the antenna line 12M2 and the first end of the antenna line 12M3. The main antenna 12M thus has a three-winding loop shape.

The repeater antenna 12R includes the antenna lines 12R1 to 12R3 made of metal mesh and provided on the antenna substrate 121, and the connection lines 12RC1 and 12RC2 made of meshless metal wire and provided on the FPC substrate 16. The connection line 12RC1 connects the first end of the antenna line 12R1 and the first end of the antenna line 12R2. The connection line 12RC2 connects a second end of the antenna line 12R2 and a first end of the antenna line 12R3. The repeater antenna 12R thus has a three-winding loop shape.

The antennas are sized to have a diagonal of about five inches (about 12.7 cm), and the antenna lines 12M1 to 12M3 as well as the antenna lines 12R1 to 12R3 each have about 300 μm in width and an interval of about 50 μm from an adjacent antenna line.

The configuration depicted in FIG. 5 includes the main antenna 12M adjusted to have the resonant frequency of 14 MHz, and the repeater antenna 12R adjusted to have the resonant frequency of 20 MHz. The EMVCo characteristic has about 3.81 V in the configuration depicted in FIG. 5. This configuration accordingly satisfies the characteristic required in the EMV specifications. The current value is 0.365 A when this output voltage value is obtained.

The configuration including the repeater antenna 12R disposed inside the main antenna 12M also achieves an effect similar to that of the first embodiment. Specifically, provision of the repeater antenna 12R leads to excellent antenna performance with expanded communication distance and range. The main antenna 12M and the repeater antenna 12R are disposed on the identical plane to achieve reduction in thickness of the entire device in comparison to a configuration including the main antenna 12M and the repeater antenna 12R disposed in layers different from each other.

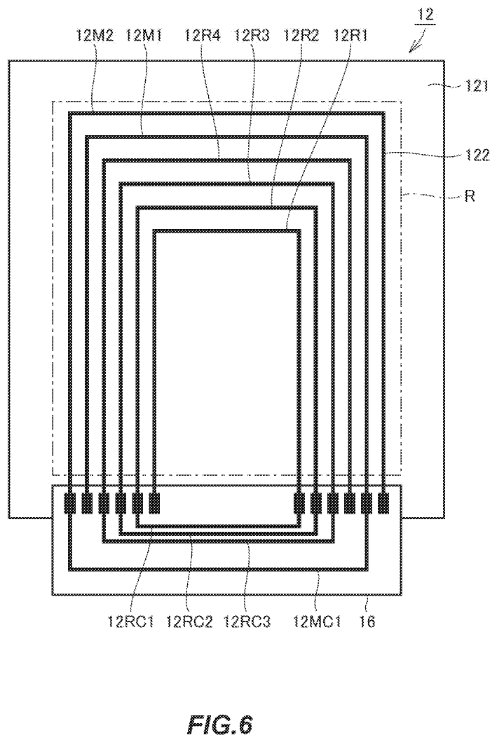

As depicted in FIG. 6, the main antenna 12M may have two and the repeater antenna 12R may have four as the number of winding. The main antenna 12M exemplified in FIG. 6 includes the antenna lines 12M1 and 12M2 made of metal mesh and provided on the antenna substrate 121, and the connection 12MC1 made of meshless metal wire and provided on the FPC substrate 16.

As exemplarily depicted in FIG. 6, the connection line 12MC1 connects the first end of the antenna line 12M1 and the first end of the antenna line 12M2. The main antenna 12M thus has a two-winding loop shape.

The repeater antenna 12R includes the antenna lines 12R1 to 12R4 made of metal mesh and provided on the antenna substrate 121, and connection lines 12RC1 to 12RC3 made of meshless metal wire and provided on the FPC substrate 16. The connection line 12RC1 connects the first end of the antenna line 12R1 and the first end of the antenna line 12R2. The connection line 12RC2 connects the second end of the antenna line 12R2 and the first end of the antenna line 12R3. The connection line 12RC3 connects a second end of the antenna line 12R3 and a first end of the antenna line 12R4. The repeater antenna 12R thus has a four-winding loop shape.

The antennas are sized to have a diagonal of about five inches (about 12.7 cm), and the antenna lines 12M1 and 12M2 as well as the antenna lines 12R1 to 12R4 each have about 300 μm in width and an interval of about 50 μm from an adjacent antenna line.

The configuration depicted in FIG. 6 includes the main antenna 12M adjusted to have the resonant frequency of 14 MHz, and the repeater antenna 12R adjusted to have the resonant frequency of 20 MHz. The EMVCo characteristic has about 3.75 V in the configuration depicted in FIG. 6. This configuration accordingly satisfies the characteristic required in the EMV specifications. The current value is 0.348 A when this output voltage value is obtained.

The configuration depicted in FIG. 6 also achieves an effect similar to that of the configuration depicted in FIG. 5. Specifically, provision of the repeater antenna 12R leads to excellent antenna performance with expanded communication distance and range. The main antenna 12M and the repeater antenna 12R are disposed on the identical plane to achieve reduction in thickness of the entire device in comparison to a configuration including the main antenna 12M and the repeater antenna 12R disposed in layers different from each other.

The numbers of winding of the main antenna 12M and the repeater antenna 12R as well as the width and the interval of the antenna lines are not limited to the specific exemplification described above, but may be appropriately adjusted to satisfy a required characteristic.

### Third Embodiment

Description is now made to the third embodiment. The third embodiment relates to a configuration in which the antenna lines of the main antenna 12M and the antenna lines of the repeater antenna 12R are disposed alternately.

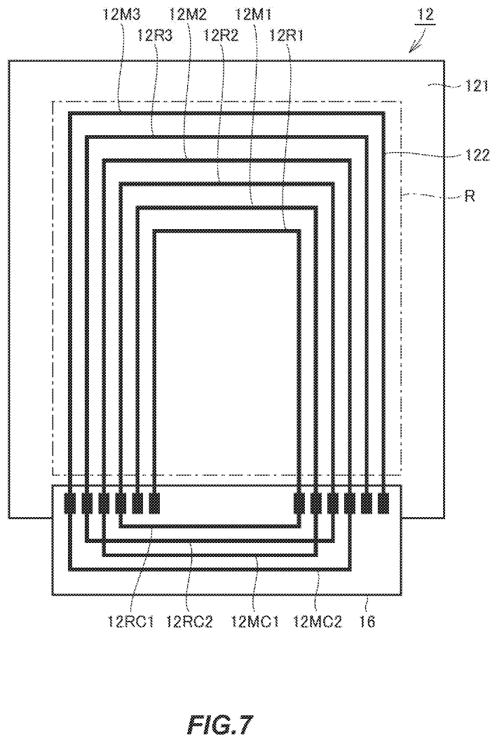

FIG. 7 is a pattern diagram depicting an exemplary configuration of the antenna layer 12 according to the third embodiment. FIG. 7 exemplarily depicts the main antenna 12M having a three-winding loop shape. The repeater antenna 12R has a three-winding loop shape.

The main antenna 12M includes the antenna lines 12M1 to 12M3 made of metal mesh and provided on the antenna substrate 121, and the connection lines 12MC1 and 12MC2 made of meshless metal wire and provided on the FPC substrate 16. The repeater antenna 12R includes the antenna lines 12R1 to 12R3 made of metal mesh and provided on the antenna substrate 121, and the connection lines 12RC1 and 12RC2 made of meshless metal wire and provided on the FPC substrate 16.

The antenna lines 12M1 to 12M3 of the main antenna 12M and the antenna lines 12R1 to 12R3 of the repeater antenna 12R are disposed alternately from the center toward an outer end of the antenna substrate 121. The antenna line 12R1 of the repeater antenna is disposed closest to an inner periphery of the antenna substrate 121, and the antenna line 12M1 of the main antenna 12M is disposed along an outer periphery of the antenna line 12R1. The antenna lines 12R2, 12M2, 12R3, and 12M3 are subsequently disposed in the mentioned order.

The connection line 12MC1 of the main antenna 12M connects the first end of the antenna line 12M1 and the first end of the antenna line 12M2. The connection line 12MC2 connects the second end of the antenna line 12M2 and the first end of the antenna line 12M3. The main antenna 12M thus has a three-winding loop shape. The connection line 12RC1 of the repeater antenna 12R connects the first end of the antenna line 12R1 and the first end of the antenna line 12R2. The connection line 12RC2 connects the second end of the antenna line 12R2 and the first end of the antenna line 12R3. The repeater antenna 12R thus has a three-winding loop shape.

As depicted in FIG. 7, the connection line 12RC2 and the connection line 12MC1 cross in a planar view. These connection lines are disposed in layers different from each other on the FPC substrate 16 so as not to be in electrical contact with each other.

The antennas are sized to have a diagonal of about five inches (about 12.7 cm), and the antenna lines 12M1 to 12M3 as well as the antenna lines 12R1 to 12R3 each have about 300 μm in width and an interval of about 50 μm from an adjacent antenna line.

The configuration depicted in FIG. 7 includes the main antenna 12M adjusted to have the resonant frequency of 14 MHz, and the repeater antenna 12R adjusted to have the resonant frequency of 20 MHz. The EMVCo characteristic has about 3.60 V in the configuration depicted in FIG. 7. This configuration accordingly satisfies the characteristic required in the EMV specifications. The current value is 0.350 A when this output voltage value is obtained.

Also in the configuration including the antenna lines of the repeater antenna 12R and the antenna lines of the main antenna 12M disposed alternately, provision of the repeater antenna 12R leads to excellent antenna performance with expanded communication distance and range. The main antenna 12M and the repeater antenna 12R are disposed on the identical plane to achieve reduction in thickness of the entire device in comparison to a configuration including the main antenna 12M and the repeater antenna 12R disposed in layers different from each other.

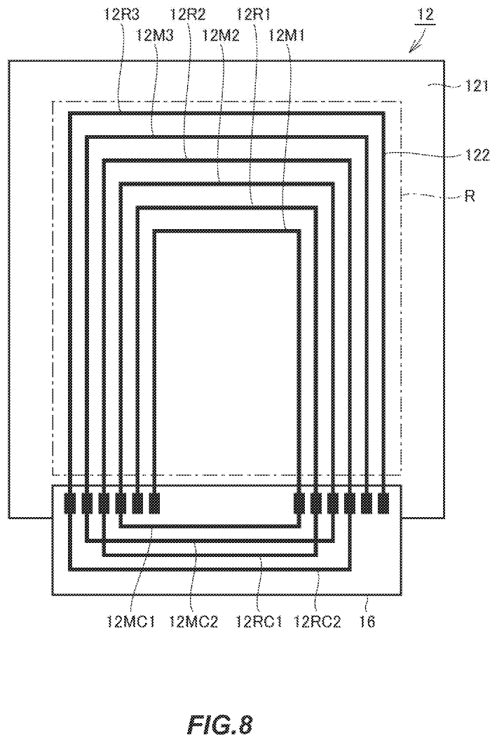

The antenna lines of the main antenna 12M and the antenna lines of the repeater antenna 12R may be inverted in positional relation from the configuration depicted in FIG. 7. In the configuration depicted in FIG. 8, the antenna 12M1 of the main antenna is disposed closest to the inner periphery of the antenna substrate 121, and the antenna line 12R1 of the main antenna 12R is disposed along an outer periphery of the antenna line 12M1. The antenna lines 12M2, 12R2, 12M3, and 12R3 are subsequently disposed in the mentioned order.

The connection line 12MC1 of the main antenna 12M connects the first end of the antenna line 12M1 and the first end of the antenna line 12M2. The connection line 12MC2 connects the second end of the antenna line 12M2 and the first end of the antenna line 12M3. The main antenna 12M thus has a three-winding loop shape. The connection line 12RC1 of the repeater antenna 12R connects the first end of the antenna line 12R1 and the first end of the antenna line 12R2. The connection line 12RC2 connects the second end of the antenna line 12R2 and the first end of the antenna line 12R3. The repeater antenna 12R thus has a three-winding loop shape.

As depicted in FIG. 8, the connection line 12RC1 and the connection line 12MC2 cross in a planar view. These connection lines are disposed in layers different from each other on the FPC substrate 16 so as not to be in electrical contact with each other.

The antennas are sized to have a diagonal of about five inches (about 12.7 cm), and the antenna lines 12M1 to 12M3 as well as the antenna lines 12R1 to 12R3 each have about 300 μm in width and an interval of about 50 μm from an adjacent antenna line.

The configuration depicted in FIG. 8 includes the main antenna 12M adjusted to have the resonant frequency of 14 MHz, and the repeater antenna 12R adjusted to have the resonant frequency of 20 MHz. The EMVCo characteristic has about 3.60 V in the configuration depicted in FIG. 8. This configuration accordingly satisfies the characteristic required in the EMV specifications. The current value is 0.357 A when this output voltage value is obtained.

As described above, the configuration depicted in FIG. 8 also includes the repeater antenna 12R to achieve excellent antenna performance with expanded communication distance and range. The main antenna 12M and the repeater antenna 12R are disposed on the identical plane to achieve reduction in thickness of the entire device in comparison to a configuration including the main antenna 12M and the repeater antenna 12R disposed in layers different from each other.

The numbers of winding of the main antenna 12M and the repeater antenna 12R as well as the width and the interval of the antenna lines are not limited to the specific exemplification described above, but may be appropriately adjusted to satisfy a required characteristic. The main antenna 12M and the repeater antenna 12R may not necessarily be equal in the numbers of winding.

### Fourth Embodiment

Description is now made to the fourth embodiment. The first to third embodiments each exemplify the main antenna 12M and the repeater antenna 12R including the antenna lines made of metal mesh. In contrast, the fourth embodiment provides, in place of the antenna layer 12, an antenna layer 22 including antenna lines disposed outside the display region and not made of metal mesh but made of meshless metal wire.

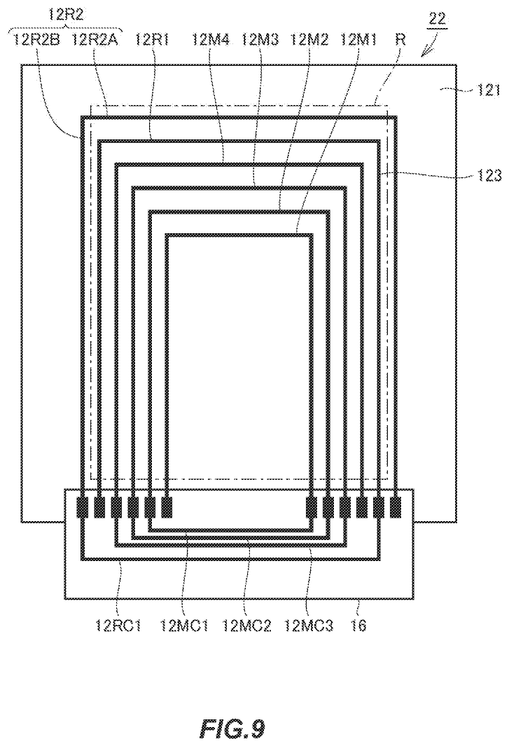

FIG. 9 is a pattern diagram depicting an exemplary configuration of the antenna layer 22 according to the fourth embodiment. As depicted in FIG. 9, the antenna layer 22 includes the antenna substrate 121 made of a synthetic resin material such as polyethylene terephthalate (PET), and an antenna pattern 123 provided on the antenna substrate 121. The antenna pattern 123 has a portion disposed inside a display region R and made of metal mesh lines (a meshed metal film), and a portion disposed outside the display region R and made of meshless metal wire. The display region R is overlapped with a pixel region of the liquid crystal module 11 on the antenna substrate 121 when the liquid crystal display apparatus 1 is viewed along the normal line. The portion outside the display region R is typically called a “frame region”.

As depicted in FIG. 9, the antenna pattern 123 includes the main antenna 12M and the repeater antenna 12R. The main antenna 12M has a four-winding loop shape, and the repeater antenna 12R is provided to surround the outer end of the main antenna 12M and has a two-winding loop shape.

The main antenna 12M includes the antenna lines 12M1 to 12M4 made of metal mesh and provided on the antenna substrate 121, and the connection lines 12MC1 to 12MC3 made of meshless metal wire and provided on the FPC substrate 16.

The connection line 12MC1 connects the first end of the antenna line 12M1 and the first end of the antenna line 12M2. The connection line 12MC2 connects the second end of the antenna line 12M2 and the first end of the antenna line 12M3. The connection line 12MC3 connects the second end of the antenna line 12M3 and the first end of the antenna line 12M4. The main antenna 12M thus has a four-winding loop shape.

The repeater antenna 12R includes the antenna lines 12R1 and 12R2, and the connection 12RC1 made of meshless metal wire and provided on the FPC substrate 16. The antenna line 12R1 is made of metal mesh and disposed in the display region R on the antenna substrate 121. The antenna line 12R2 includes a portion 12R2A disposed in the display region R and made of metal mesh, and a portion 12R2B disposed outside the display region R and made of meshless metal wire. The connection line 12RC1 connects the first end of the antenna line 12R1 and the first end of the antenna line 12R2. The repeater antenna 12R thus has a two-winding loop shape.

In the antenna line 12R2 of the repeater antenna 12R, the portion 12R2B disposed outside the display region R and made of meshless metal wire may be made of a material same as that for the connection line 12RC1 or may be made of a different material. The portion 12R2B made of meshless metal wire has width appropriately set in accordance with a desired resistance value of the repeater antenna 12R.

The antenna line disposed outside the display region R (in the frame region) and made of meshless metal wire achieves the following advantages effect. An antenna line made of metal mesh needs to have decrease in mesh pitch or increase in width in order to reduce antenna resistance. These measures leads to deterioration in light transmissivity in the region provided with the antenna line made of metal mesh and deterioration in display quality of the display apparatus. In contrast, the present embodiment provides the antenna line positioned outside the display region R and made of meshless metal wire that is lower resistance value than metal mesh, to decrease the resistance value of the entire antenna line and improve antenna performance.

The configuration depicted in FIG. 9 corresponds to a modification example of the configuration depicted in FIG. 2 in the first embodiment. In the configuration depicted in each of FIGS. 4 to 8, the antenna line disposed outside the display region R (in the frame region) may be made of meshless metal wire.

### MODIFICATION EXAMPLES

The embodiments described above are merely exemplified for implementation of the present invention. The present invention should not be limited to the above embodiments, but can be implemented with appropriate modifications to any of the above embodiments without departing from the spirit of the present invention.

The above embodiments each exemplify an antenna configuration in which the antenna lines are disposed in parallel with a long side and a short side of the antenna substrate 121 having a rectangular shape to achieve totally six as the number of winding loops. The antenna lines should not be limited to six as the number of winding loops, but may have any one of two to five, seven or more as the number of winding loops. The antenna lines may have appropriate shapes and appropriate numbers of winding under a condition where the main antenna and the repeater antenna can be separated from each other. The antenna substrate may have a shape other than the rectangular shape. The antenna substrate may have a triangular shape, a polygonal shape of at least a pentagonal shape, or any other appropriate shape such as an elliptical shape. The antenna lines may alternatively be shaped not following an edge of the antenna substrate. For example, an antenna substrate having a rectangular shape may be provided thereon with antenna lines patterned to have a triangular shape, a polygonal shape of at least a pentagonal shape, an elliptical shape, or the like.

The above embodiments each exemplify implementation of the display apparatus as the liquid crystal display apparatus including the antenna layer and the liquid crystal module combined with each other. The above embodiments should not be limited to the liquid crystal display apparatus, but can alternatively provide any other appropriate display apparatus such as an organic EL device.

The above embodiments each exemplify the display apparatus including the antenna layer. The present invention is also applicable to an antenna device including only the antenna layer without including the display module.

### REFERENCE SIGN LIST

1 liquid crystal display apparatus
11 liquid crystal module
12 antenna layer
13 touch panel
14 adhesive member
15 air gap
16 FPC substrate
17 ferrite sheet
121 antenna substrate
122 antenna pattern
12M main antenna
12R repeater antenna

1. An antenna device comprising:
an antenna substrate;
a main antenna configured to transmit and receive information through near field wireless communication, and
a repeater antenna; wherein
the main antenna and the repeater antenna are disposed on a principal surface of the antenna substrate.

2. The antenna device according to claim 1, wherein
the main antenna has a loop shape, and
the repeater antenna has a loop shape surrounding an outer periphery of the main antenna.

3. The antenna device according to claim 1, wherein
the repeater antenna has a loop shape, and
the main antenna has a loop shape surrounding an outer periphery of the repeater antenna.

4. The antenna device according to claim 1, wherein
the main antenna has a loop shape,
the repeater antenna has a loop shape, and
the main antenna and the repeater antenna are disposed alternately from a center toward an outer periphery of the antenna substrate.

5. The antenna device according to claim 1, further comprising
a wiring substrate connected to the antenna substrate, wherein
the main antenna and the repeater antenna include connection lines provided on the wiring substrate.

6. The antenna device according to claim 5, wherein the connection lines are at least partially disposed in layers different from each other on the wiring substrate.

7. A display apparatus comprising:
the antenna device according to claim 1; and
a display module configured to display an image.

8. The display apparatus according to claim 7, wherein
the display module is stacked on the antenna device, and
the main antenna and the repeater antenna are at least partially made of metal mesh.

9. The display apparatus according to claim 8, wherein the main antenna and the repeater antenna have a portion disposed in a region corresponding to outside a display region of the display module on the antenna substrate, and the portion is made of meshless metal wire.
